(19) United States
(12) Patent Application Publication
(10) Pub. No.: US 2011/0143323 A1
(43) Pub. Date: Jun. 16, 2011

(54) LANGUAGE TRAINING METHOD AND SYSTEM

(76) Inventor: Robert A. Cohen, Honolulu, HI (US)

(21) Appl. No.: 12/897,479

(22) Filed: Oct. 4, 2010

Related U.S. Application Data
(60) Provisional application No. 61/286,328, filed on Dec. 14, 2009.

(51) Int. Cl. G09B 19/06

(52) U.S. Cl. 434/157

(57) ABSTRACT

A language training system allows students to receive on-demand training in language skills with remotely situated instructors. The training is provided in diverse languages and topics. A system includes a database of conversations a student may select from. After a conversation is selected, the student also selects an instructor to provide the training. The system established real-time communication between the student and selected instructor and supply a script for the selected conversation.

### CROSS-REFERENCE TO RELATED APPLICATION

This application claims priority, under 35 U.S.C. §119(e), from U.S. Provisional Application No. 61/286,328, filed Dec. 14, 2009, the disclosure of which is incorporated herein by reference in its entirety.

### FEDERALLY-SPONSORED RESEARCH OR DEVELOPMENT

Not Applicable.

### BACKGROUND

This disclosure relates to language learning and training systems and, in particular, to automated systems for arranging real-time connections between language training participants (e.g., one or more instructors and one or more students) that are physically remote from one another.

Second or foreign languages are often taught to students in formal classroom settings. Students may also learn a language by self-study using study materials such as books, audio recordings, and software packages. These methods may prepare students to handle simple communication tasks in the new language, such as ordering meals or asking for directions, but they may less than adequately prepare the students for engaging in and understanding conversations in the new language.

Students often learn to read and write second or foreign languages fluently but are not able to effectively converse in that language. Students can often understand the spoken second or foreign language and yet be unable to speak it correctly. There are a number of reasons for this.

Traditional classroom learning may be hampered by lack of available teachers with native language skills. The classroom setting may not provide adequate language practice for students, particularly as some students may be more advanced in their study than others. Additionally, many students are not confident enough to practice speaking a new language in the presence of others and are embarrassed to do so in the classroom setting. Thus, a student may fail to master the proper pronunciation and listening comprehension required to converse comfortably in the new language. Similarly, self-study students may not receive sufficient feedback on their performance to become comfortable using the new language, and they may lack the training necessary to become confident conversing with others in the new language.

Language courses are commonly limited in vocabulary, conversation topics, and repetition of practices, and students may not be able to receive instruction in subject areas of particular interest to them. Additionally, foreign language students may experience a quick decay in their skills from non-use. Polishing and maintaining their previously learned skills may require a formal refresher course or a trip to the foreign country to converse with native speakers.

### SUMMARY

Accordingly, there is a need for an on-demand, real-time, automated system to provide language students with conversational instruction and training in a selected language in a wide variety of topics or unscripted conversation, with instructors who are native speakers in the selected language. Such a system would provide the utmost flexibility in time, place, and budget for the mutual convenience of all participants. Thus, in accordance with the present disclosure, an automated system is provided to connect a student with a remotely situated instructor, and to provide a mechanism for instruction and practice in foreign language conversation in any of a wide variety of topics of interest to the student. In a disclosed embodiment, the system allows a student to select a practice conversation script in a particular language and topic, and an instructor who is a native speaker in the selected language and who is knowledgeable, or at least conversant, in the selected topic. The system then connects the student and the instructor, and controls the real-time practice of the selected conversation.

The student is the buyer of a service, and the instructor is the seller of a service. The price of the service is determined by the market through negotiation between the buyer (student) and the seller (instructor). The price can also be set by auction or by the owner of the automated system. Any native speaker fluent in a particular language can become an instructor or seller, without the need for any special skill or training. The system enables any untrained native speaker to perform as an expert instructor. The system controls the entire training session and provides conversational scripts for the buyer (student) and seller (instructor) to communicate effectively. Students and instructors also participate in a social network open to other students and instructors. Buyer (student) and seller (instructor) reviews and rankings are components of the social networking application and create an open marketplace to help determine the appropriate service price and provide the students with confidence in knowing the level of competence of the instructor selected.

In one aspect, a method for language training in accordance with an exemplary embodiment of this disclosure may be broadly characterized by (a) receiving a selection by a first user (buyer or student) of a selected conversation script in a selected language from a conversation database; (b) receiving the first user's selection of a second user (seller or instructor); (c) establishing agreement between the first and second users on terms of a training session, confirming the selected conversation script, and authorizing a charge to the buyers account at the agreed price; (d) establishing voice communication between the first and second users; (e) supplying the selected conversation script and interactive training session instructions and procedures to the first and second users; and (f) conducting the training session between the first and second users using the selected conversation script in the selected language. The method may also include a preliminary step of establishing a first account for the first user and a second account for the second user, and a further step of updating the first and second accounts when the training session is completed.

In another aspect, a language training system in accordance with an exemplary embodiment of this disclosure may be broadly characterized by a computer system (e.g., a server) including storage containing a conversation script database and a real time instructor database; a first interne-enabled client system configured for use by a first user (e.g., a student), the first client system providing a first interface to the computer system to access the conversation script database and the instructor database; a second interne-enabled client system for use by a second user (e.g., an instructor), the second client providing a second interface to the computer system to access the conversation script database and the instructor database; and a real-time communication system configured to establish voice communication between the first and second users using a conversation script selected from the conversation script database. In a particular embodiment, the system includes a processor that may be programmed to provide account management/payment functionality and/or social networking/rating functionality.

In another aspect, a method for language training in accordance with an exemplary embodiment of this disclosure may be broadly characterized by receiving a selection of a conversation from a first client system associated with a student; presenting available instructors to the first client system based on the selected conversation; receiving a selection of an instructor of the available instructors from the first client system; establishing real-time communication between the first client system and a second client system associated with the selected instructor; and supplying a script for the selected conversation to the first client system and the second client system.

In another aspect, a computer-readable medium in accordance with an exemplary embodiment of this disclosure may be broadly characterized as containing program instructions including instructions that receive a selection of a conversation from a first client system associated with a student; instructions that present available instructors to the first client system based on the selected conversation; instructions that receive a selection of an instructor of the available instructors from the first client system; instructions that command establishing real-time communication between the first client system and a second client system associated with the selected instructor; and instructions that supply a script for the selected conversation to the first client system and the second client system.

### BRIEF DESCRIPTION OF THE DRAWINGS

FIG. 1 is a block diagram of an exemplary embodiment of a language training system in accordance with aspects of the disclosure;

FIG. 2 is a block diagram showing a more detailed view of the computer system used in the language training system of FIG. 1, and showing the communication linkage between the users of the language training system;

FIG. 3 is a flowchart of an exemplary embodiment of a method for language training in accordance with aspects of the disclosure; and

FIG. 4 is another flowchart of an exemplary embodiment of a method for language training in accordance with aspects of the disclosure.

### DETAILED DESCRIPTION

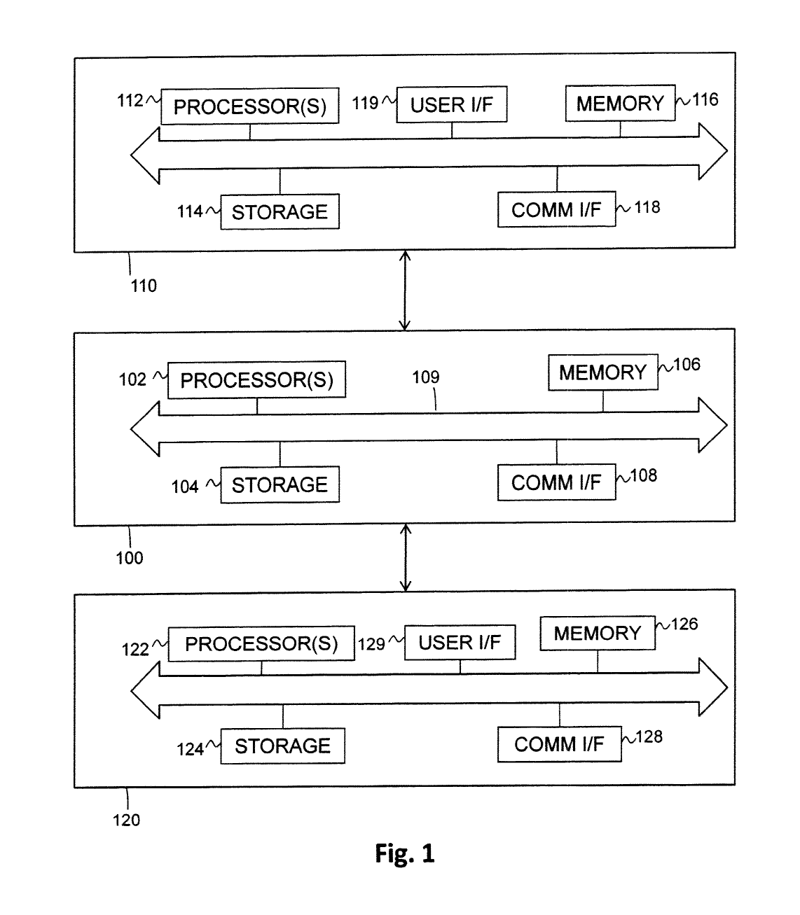

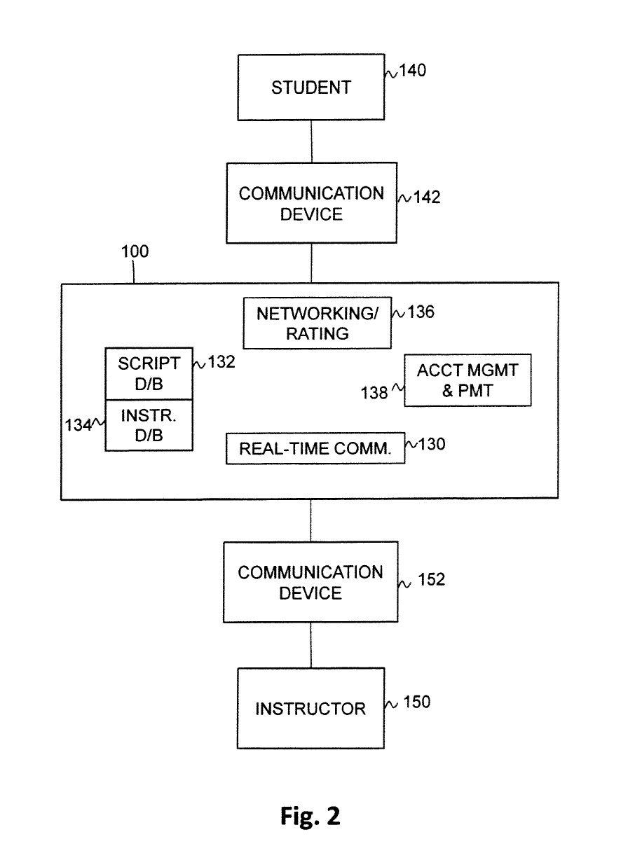

FIGS. 1 and 2 illustrate an exemplary embodiment of a language training system in accordance with aspects of the disclosure. In the illustrated embodiment, the language training system includes three subsystems: a computer system 100 (advantageously a server), a first or student client system 110 associated with a first user or student, and a second or instructor client system 120 associated with a second user or instructor. The computer system 100 is generally controlled by a provider of the language training system. Although a single instructor client system and a single student client system are illustrated in FIG. 1, an embodiment commonly includes many of each, with virtually no limit on the number of simultaneous users.

As illustrated, the computer system 100 may typically include a processor 102, a storage device or subsystem 104, a memory device or subsystem 106, and a communication interface 108. The devices and subsystems of the computer system 100 are connected by a bus 109. The bus 109 may include multiple buses connected by bridges. In some embodiments, the processor 102 may include multiple processors, multiple cores, multi-threaded processors, or a combination thereof. The storage device 104 may include magnetic and optical disks and tapes, integrated circuits, or the like, operative to hold data by any means. In one embodiment, the storage device 104 stores operating system program files, application program files, and other files. The processor 102 executes programmable instructions out of the memory device 106 (e.g., random-access memory). For example, the processor 101 may execute computer-executable process steps of an application program so that it may properly execute the application program. When executing stored computer-executable process steps from the storage device 104, the processor 101 may store and execute the process steps out of the memory device 106. The communication interface 108 provides a pathway for communication between the computer system 100 and other systems. The communication interface 108 may, for example, include an Ethernet, standard or proprietary high-speed bus, or telco interface and may send and receive data and voice signals. In some embodiments, the communication interface 108 may be external to the computer system 100.

The student client system 110 may typically have at least one processor 112, a storage device or subsystem 114, a memory device or subsystem 116 (which may optionally be combined with the storage device or subsystem 114), a communication interface 118, and a user interface 119. The communication interface 118 generally provides an Internet connection. The user interface 119 provides information to and receives inputs from the first user or student. The student client system 110 may, in some embodiments, be a mobile phone device and include a display, touch screen, speaker, microphone, and keyboard in the user interface 119. The first user or student may interact with the student client system 110 using a web browser or another graphical or audio user interface. Similarly, the instructor client system 120 may typically have at least one processor 122, a storage device or subsystem 124, a memory device or subsystem 126 (which may optionally be combined with the storage device or subsystem 124), a communication interface 128, and a user interface 129.

As shown in FIG. 2, the computer system 100, in one embodiment, is an internet-enabled, networked computer server and includes data and software modules. The modules are typically stored in the storage device 104 of the computer system 100. A real-time communication module 130 is configured to manage real-time communication to and from the instructor and the student. The real-time communication module 130 provides voice and data communication. In some embodiments, the real-time communication module 130 provides video communication, for example, video conferencing. The voice communication may be by way of, for example, a voice-over-internet call utilizing the communication interface 108 of the computer system 100. The real-time communication module 130 may also control voice communications utilizing services external to the computer system 100, for example, by initiating a call using the public switched telephone network including wired and mobile connections. The real-time communication module 130 may also stream communication scripts to the student and the instructor.

A conversation script database 132 is also included in the computer system 100 and stores conversation scripts. The conversation script database 132 may be updated, for example, to add or revise conversation scripts. The conversation scripts are stored and referenced by language and topic. For example, there may be conversation scripts in a plurality of languages, relating to topics such as food, automobiles, science, literature, music, history, hobbies, etc., and these topics are cataloged or indexed for searching. The conversation scripts may additionally be ranked by a language proficiency level, such as beginner, intermediate, and advanced, indicative of an appropriate student level of proficiency. Each conversation script in the conversation script database 132 includes a communication script for both instructor and student. Provided with a detailed script, native speakers may serve as instructors for conversations in their native language. A conversation script database 132 may include additional instructional materials, for example, translations, dictionaries, pronunciation guides, or vocabulary lists associated with the conversation scripts.

An instructor database 134 is also included in the computer system 100 and includes information about instructors. The instructor information includes an indication of those instructors who are available. Available instructors are those who have agreed to provide services in the language training system and are currently on-line (or readily available) and ready to enter into a training session with a student. The instructor database 134 includes identification of instructors and their respective native languages. In some embodiments, the instructor information includes reviews and rankings of the instructors. Instructor availability is updated in real time, for example, to indicate that an instructor is currently on-line, off-line, engaged with a student, or is available to sell his or her services.

A social networking/rating module 136 is also included in the computer system 100 and provides for students and instructors to review and rank other students and instructors. The social networking/rating module 136 also provides a mechanism that may be used to help determine an appropriate price for a seller (instructor) and buyer (student) to agree upon. Additionally, the social networking/rating module 136 may provide a student with confidence to trust a level of competence of an instructor, for example, based on the number of reviews. The social networking/rating module 136 also provides a forum for students and instructors, and for prospective students and prospective instructors, to engage in typical social networking activities. The social networking/rating module 136 may utilize the instructor database 134 by reading and writing appropriate data.

An account management and payment module 138 is also included in the computer system 100 and provides comprehensive account management for both buyers (students) and sellers (instructors). In conjunction with the social networking/rating module 136 discussed above, the account management and payment module 138 may optionally be operated in an “auction” mode or any other suitable modality that may be employed by the buyers and sellers to determine an appropriate price for the sale and purchase of the language training services. The account management and payment module 138 may also be used to set up accounts for the buyers and sellers and to exchange funds for the purchase and sale of those services.

As shown in FIG. 2, the student or buyer 140 may access the language training system on the computer system 100 by way of a first communication device 142, while the instructor or seller 150 may access the language training system on the computer system 100 by way of a second communication device 152. The first and second communication devices 142, 152 may, in some embodiments, be the student and instructor client systems 110, 120. The first and second communication devices 142, 152 may also be ordinary telephone devices and use, for example, voice prompts and touchtone responses rather than a graphical user interface. The first and second communication devices 142, 152 may utilize data communications such as an Internet connection or voice communications such as a telephone connection.

Typically, the student 140 accesses the conversation script database 132 to find and select a topic of interest to the student 140 in the language in which the student desires to be conversant. The student 140 then accesses the instructor database 134 to find and select an instructor available to provide instruction using the selected conversation script in the selected language. The student 140 may utilize pricing information in selecting the instructor. The student 140 may additionally use the social networking/rating module 136 to aid in selecting an instructor, for example, based on feedback of prior student experiences with the instructors. After the student 140 selects a conversation script and an instructor, the real-time communication module 130 of the computer system 100 establishes voice communication between the student 140 and the selected instructor 150. In some embodiments, the account management and payment module 138 may complete an agreement between the student 140 and the instructor 150 as to terms of a training session before voice communication between the student 140 and the instructor 150 is established. In other embodiments, the student 140 and the instructor 150 may agree to terms of a training session using the voice communication. If agreement between the student 140 and instructor 150 is not reached, the language training system allows the student 140 to terminate actions with the selected instructor. The student 140 may then select a second instructor from the list of available instructors, and proceed as above with the second instructor. Once communication is established and a training session is agreed to by the student 140 and instructor 150, they are connected audibly (and, optionally, visually, if a video connection is available and selected). The language training system will supply, in real-time, the selected conversation script from the conversation script database 132. Additional instructional materials may also be supplied.

Typically, the instructor 150 accesses the instructor's account which then accesses the instructor database 134 to provide information on his or her availability. The instructor 150 may additionally access the social networking/rating module 136 to receive and provide performance feedback. The social networking/rating module 136 may provide the student 140 and the instructor 150 with different views. Alternatively, there may be separate student and instructor networking/rating modules that are connected to each other through, for example, the account management and payment module 138.

The block diagrams of FIGS. 1 and 2 are exemplary only, and any specific embodiment may omit some features, add other features, or differently arrange features. For example, an embodiment may provide the real-time communication module 130 external to the computer system 100.

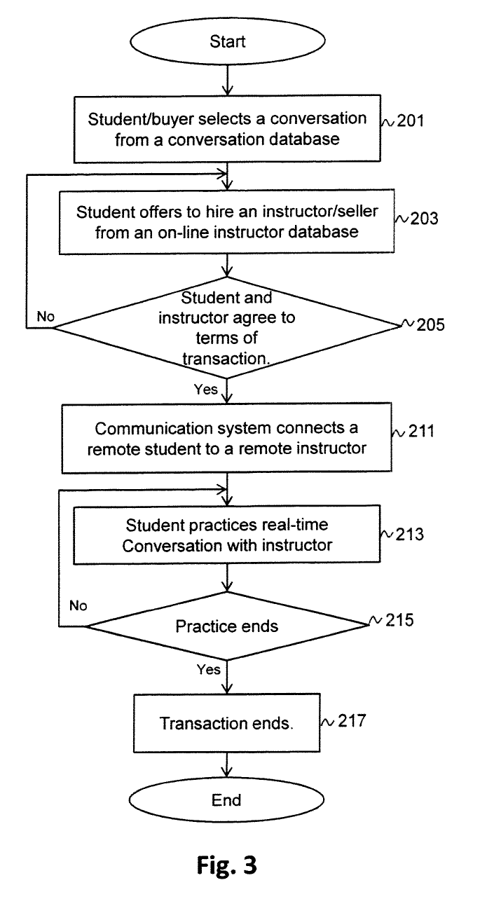

FIG. 3 is a flowchart of an exemplary embodiment of a method or process for conversational language training in accordance with aspects of the disclosure. The process may be performed by hardware, software, firmware, or a combination thereof. The process may be performed by the language training system of FIGS. 1 and 2. Additionally, instructions for performing the process may be stored on a computer-readable medium. The process acts as an on-demand intermediary to connect remote instructors and remote students, and to provide conversations for practice in language learning.

The process begins in step 201 where the student selects a conversation script from a conversation script database, for example, the conversation script database 132 of the language training system of FIGS. 1 and 2. Before accessing the system, as a preliminary step, the student may enroll or register to use the system by, for example, establishing a student or buyer account, in which the student/buyer supplies to the computer system student information, such as languages they want to practice, contact information, preferences, and payment method. When accessed, the process receives an indication of the selected conversation from the student and presents the student with a list of instructors from the instructor database who are available and able to instruct the student using the selected conversation script. The available instructors are those who have previously enrolled or registered, in a preliminary step, to sell services via the system, for example, by establishing an instructor or seller account in which the instructor/seller supplies instructor information, such as their native languages, contact information, preferences, and method for receipt of payment. The process may determine the availability of instructors capable of instructing the student in the selected conversation using a database, such as the instructor database 134 shown in FIG. 2.

In step 203, the process receives a student offer to hire a selected instructor and conveys the offer to the selected instructor. The offer includes terms such as the conversation script to be used, the length (duration) of the training session, the price per minute (or other period of time) of the training session, and the payment method. In step 205, the process tests if the student and the selected instructor agree to the terms. If the terms are agreed, the process continues to step 211; otherwise, the process returns to step 203 where the student may make a new offer.

In step 211, the process connects the student and instructor, for example, using the real-time communication module 130 of FIG. 2. The connection between student and instructor may also supply the selected conversation script to each party. In step 213, the student practices conversation with the instructor using the selected conversation script. In step 215, the process checks if the practice conversation has ended. If so, the process continues to step 217 and completes the transaction and updates the student and instructor accounts. Otherwise, the process goes back to step 213. The practice conversation may end, for example, based on expiration of a time limit agreed to in step 205. Alternatively, the practice may continue, for example, when the student and the instructor agree to extend the practice session.

The process accordingly allows students to practice conversations in diverse subjects in a selected language, at a time and a place of the student's choosing. Similarly, the process allows the instructor to provide training at a time and a place of the instructor's choosing. The practice is with a native speaking instructor, and there is no need for the student or the instructor to travel for an in-person meeting. Moreover, there is no need either for prior scheduling or specialized equipment on the part of either the student or the instructor.

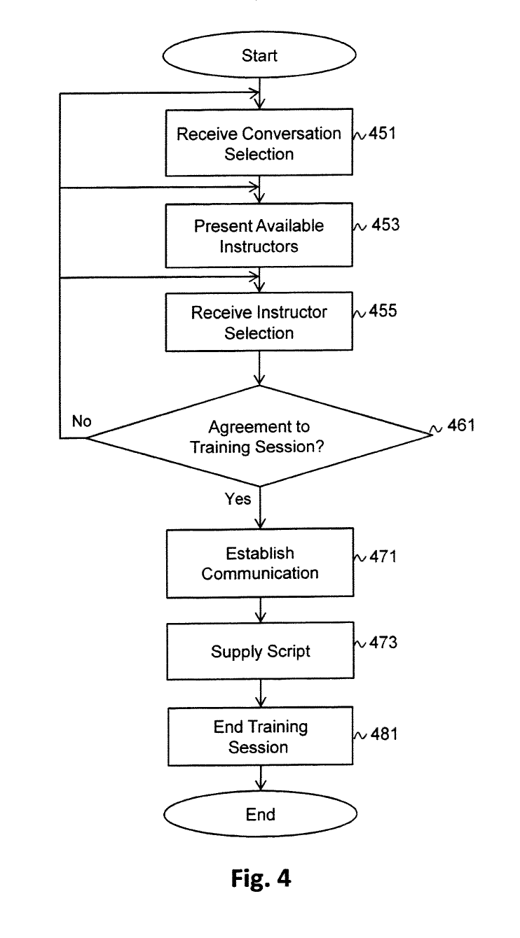

FIG. 4 is a flowchart of a process for language training in accordance with aspects of the disclosure. The process may be performed by hardware, software, firmware, or a combination thereof. For example, the process may be performed by program instructions stored in and executed by the computer system 100 of FIGS. 1 and 2. The program instructions may be stored, for example, on a non-transitory computer-readable medium such as a compact disc (CD), digital versatile disk (DVD), read-only memory (ROM), floppy disk, hard disk, or flash drive. The process connects remote instructors and remote students and provides conversations for practice in language learning.

In step 451, the process receives a selection of a conversation script from a student. The student may supply the selection, and otherwise interact with the process, by way of a student client system. The process may supply a conversation script database to the student for the student to select from. The process may present a portion of the conversation script database to student, for example, a portion of the database that contains conversations in a particular language, a particular topic, and at a particular language proficiency level.

In step 453, the process presents the student with a list of available instructors for the selected conversation script. The process may select the list of available instructors by selecting instructors from an instructor database who are natively fluent in the language of the selected conversation script and are currently available to instruct the student.

In step 455, the process receives a selection of an instructor from the student. In some embodiments, a set of instructors may be selected with a particular one of the instructors selected in subsequent process step.

In step 461, the produce determines whether the student and the selected instructor have agreed to terms for a training session. The terms for the training session may be agreed to by default, for example, using a pre-established fee associated with the selected instructor. The process may also run a reverse auction between the instructors in a selected set of instructors. In other instances, the process may provide for direct negotiation between the student and the selected instructor. When the process determines that terms have been agreed to, the process continues to step 471; otherwise, the process returns to one of steps 451, 453, or 455. Which of the steps the process returns to may be fixed or determined based on preferences of the student or a selection received from the student.

In step 471, the process establishes real-time communication between the student and the instructor. The real-time communication includes audio communication. Video communication may also be established by the process. The instructor may interact with the process and the student by way of an instructor client system. The process may establish the communication using, for example, Internet connections or landline or mobile telephone connections. In some embodiments, the process establishes the real-time communication between the student and the instructor before determining whether the student and the instructor have agreed to the terms for the training session. Accordingly, the real-time communication may be used to establish the terms for the training session.

In step 473, the process supplies the selected conversation script to the student and the instructor. The script may be supplied as textual information that the student and instructor scroll through as they progress through the training session. The process may also supply the script contemporaneously to the training session, for example, in a manner analogous to a karaoke machine. The process may supply additional textual, graphical, or audio information to augment the training session.

In step 481, the process ends the training session. The process may end the training session, for example, based on the process reaching the end of the conversation script supplied in step 473, expiration of a time limit, or express termination by the student or the instructor. The process ends the real-time communication established in step 471. The process generally updates accounts of the student and the instructor to reflect completion of the training session. The process may also prompt the student and instructor to use a social networking/rating system. Thereafter, the process ends.

Although the present invention has been described with reference to specific embodiments, these embodiments are illustrative only and not limiting. Many other applications and embodiments of the present invention will be apparent in light of this disclosure and the following claims.

What is claimed is:

1. A method for providing on-demand language training for a student from an instructor, the method comprising:
(a) providing a computer system including a storage device in which is stored (i) a conversation script database containing a plurality of conversation scripts, and (ii) an instructor database containing information for a plurality of instructors;
(b) providing communication between the student and the computer system whereby the student selects a conversation script from the conversation script database and an instructor from the instructor database;
(c) establishing communication between the student and the selected instructor to allow the student and the selected instructor to engage in a negotiation of terms of a language training session;
(d) if the negotiation results in an agreement between the student and the selected instructor, establishing voice communication between the student and the selected instructor to permit conversation between the student and the instructor using the selected conversation script in accordance with the terms of the language training session; and
(e) if the negotiation does not result in an agreement between the student and the instructor, returning to step (b) to permit the student to select another instructor from the instructor database.

2. The method of claim 1, wherein the step of providing communication between the student and the computer system includes:
(b)(1) in response to the selection of a selected conversation script by the student, providing the student with a list of instructors that are available to converse with the student using the selected conversation script; and
(b)(2) receiving, from the student, a selected instructor from the list.

3. The method of claim 1, further comprising the step of real-time updating the instructor database.

4. The method of claim 1, wherein the terms of the language training session comprise a price and a duration.

5. A system for providing real-time language training for a student from an instructor, comprising:
a computer system including storage device in which is stored (i) a conversation script database containing a plurality of conversation scripts, and (ii) an instructor database containing information for a plurality of instructors;
a first internet-enabled client configured for use by a student, the first client providing a first interface to the computer system to access the conversation script database and the instructor database;
a second internet-enabled client for use by an instructor, the second client providing a second interface to the computer system to access the conversation script database and the instructor database; and
a real-time communication system configured to establish voice communication between the student and the instructor using a conversation script selected from the conversation script database for practicing the selected language.

6. The system of claim 5, wherein the computer system includes a processor programmed to provide an account management/payment functionality.

7. The system of claim 5, wherein the computer system includes a processor programmed to provide a social networking/rating functionality.

8. A method for language training, the method comprising the machine-executed steps of:
receiving a selection of a conversation from a first client system associated with a student;
presenting available instructors to the first client system based on the selected conversation;
receiving a selection of an instructor of the available instructors from the first client system;
establishing real-time communication between the first client system and a second client system associated with the selected instructor; and
supplying a script for the selected conversation to the first client system and the second client system.

9. The method of claim 8, further comprising determining whether the student and the selected instructor have agreed to terms of a training session, and wherein supplying the script is performed after determining that the student and the selected instructor have agreed to terms.

10. The method of claim 8, further comprising presenting at least a portion of a conversation database comprising conversations to the first client system, and wherein the selection of the conversation is of one of the conversations in the conversation database.

11. The method of claim 10, wherein the conversation database comprises conversations in a plurality of languages and a plurality of topics.

12. The method of claim 8, wherein presenting available instructors to the first client system presents instructors selected from an instructor database comprising instructor information.

13. The method of claim 8, wherein the first client system and the second client system are remotely situated.

14. The method of claim 8, further comprising:
receiving a selection of a second conversation from a third client system associated with a second student;
presenting available instructors to the third client system based on the selected second conversation;
receiving a selection of a second instructor of the available instructors from the third client system;
establishing real-time communication between the third client system and a fourth client system associated with the second instructor; and
supplying a script for the selected conversation to the third client system and the fourth client system.

15. The method of claim 14, wherein the real-time communication between the first client system and a second client system and the real-time communication between the third client system and a fourth client system are concurrent.

16. A non-transitory computer-readable medium containing program instructions, the program instructions comprising:
instructions that receive a selection of a conversation from a first client system associated with a student;
instructions that present available instructors to the first client system based on the selected conversation;
instructions that receive a selection of an instructor of the available instructors from the first client system;
instructions that command establishing real-time communication between the first client system and a second client system associated with the selected instructor; and
instructions that supply a script for the selected conversation to the first client system and the second client system.

17. The non-transitory computer-readable medium of claim 16, wherein the program instructions further comprise instructions that determining whether the student and the selected instructor have agreed to terms of a training session, and wherein the instructions that supply the script for the selected conversation to the first client system and the second client system are performed after determining that the student and the selected instructor have agreed to terms.

18. The non-transitory computer-readable medium of claim 16, wherein the program instructions further comprise instructions that present at least a portion of a conversation database comprising conversations to the first client system, and wherein the selection of the conversation is of one of the conversations in the conversation database.
